(19) United States
(12) Patent Application Publication
(10) Pub. No.: US 2021/0051469 A1
(43) Pub. Date: Feb. 18, 2021

(54) COMPUTER SOFTWARE PROGRAM FOR CONTROLLING DATA COMMUNICATION AND TERMINAL FUNCTION OF PORTABLE INFORMATION TERMINAL, AND DATA COMMUNICATION CONTROL SERVER

(71) Applicant: FREEBIT CO., LTD., Tokyo (JP)

(72) Inventors: Hiroshi OIZUMI, Tokyo (JP); Atsuki ISHIDA, Tokyo (JP)

(21) Appl. No.: 16/967,842

(22) PCT Filed: Feb. 15, 2019
(86) PCT No.: PCT/JP2019/005520

§ 371 Date: Aug. 6, 2020

(30) Foreign Application Priority Data
Feb. 19, 2018 (JP) 2018-026945

(51) Int. Cl. H04W 8/22; H04W 8/00

(52) U.S. Cl. CPC H04W 8/22; H04W 8/005

(57) ABSTRACT

There is provided an app 14 installed in a mobile information terminal with a SIM (Subscriber Identity Module) 3 implemented therein, for controlling data communication, terminal functions and the like of the mobile information terminal 4, wherein the SIM is provided by a telecommunications carrier, wherein the app causes the mobile information terminal 4 to send an existence signal, indicating that the app is being executed, to a communication control server 14 of the telecommunications carrier in response to a predetermined existence confirmation command, and wherein if the data communication control server 14 does not receive the existence signal from the app 13 sent in response to the existence confirmation command, the data communication control server 14 sends a command to a mobile network connection controller 9 connected to the mobile information terminal 4 to stop data communication by the SIM.

### FIELD OF THE INVENTION

The present invention relates to a computer software program and a data communication control server for controlling data communication, terminal functions and the like of a mobile information terminal used for a mobile network.

### BACKGROUND OF THE INVENTION

In recent years, as the mobile information terminals such as smartphones and the like are more widely used, various apps have been developed, and they have been installed and used according to user preferences.

Some of the telecommunications carriers, app service operators and the like providing data communication services try to provide basic control related to terminal management and the like of mobile information terminals in the form of an app for deploying their own unique services. However, when a user deleted an app such as the above in certain ways, a telecommunications carrier such as the above sometimes lost the control related to terminal management.

### SUMMARY OF THE INVENTION

### Problem to be Solved by the Invention

Considering the above challenge, the purpose of the present invention is to provide means for effectively preventing the inability to control terminal management caused by a user deleting the user's app related to the terminal management control, which app provided by a telecommunications carrier.

### Means for Solving the Problem

In order to achieve the above object, according to a first principal aspect of the present invention, there is provided a computer software program installed in a mobile information terminal having implemented therein a SIM (Subscriber identity module) provided by a telecommunications carrier, said computer software program for controlling data communication, terminal functions and the like of the mobile information terminal, wherein the computer software program causes the mobile information terminal to send an existence signal, indicating that the computer software program is being executed, to a communication control server of the telecommunications carrier in response to a predetermined existence confirmation command, and wherein if the data communication control server does not receive the existence signal from the program sent in response to the existence confirmation command, the data communication control server sends a command to a mobile network connection controller connected to the mobile information terminal to stop data communication by the SIM.

According to one embodiment of the present invention, the existence confirmation command is received from the data communication control server, and if the data communication control server does not receive the existence signal from the program sent in response to the existence confirmation command within a certain time period, the data communication control server sends a command to the mobile network connection controller to stop data communication by the SIM.

According to another embodiment, the existence confirmation command is generated at regular time intervals within the mobile information terminal, and if the data communication control server does not receive the existence signal from the program sent in response to the existence confirmation command at regular time intervals, the data communication control server sends a command to the mobile network connection controller to stop data communication by the SIM.

According to yet another embodiment, there is provided a computer software program, further comprising a data communication control module for generating a command regarding data communication control based on an event detected within the mobile information terminal; and sending the command to the data communication control server.

Also, according to a second principal aspect of the present invention, there is provided a data communication control server for communicating with a computer software program installed in a mobile information terminal having implemented therein a SIM (Subscriber identity module) provided by a telecommunications carrier, the computer software program for controlling data communication, terminal functions and the like of the mobile information terminal, wherein the computer software program causes the mobile information terminal to send an existence signal, indicating that the program is being executed, to a communication control server of the telecommunications carrier in response to a predetermined existence confirmation command, and wherein if the data communication control server does not receive the existence signal from the program sent in response to the existence confirmation command, the data communication control server sends a command to a mobile network connection controller connected to the mobile information terminal to stop data communication by the SIM.

Characteristics of the present invention other than the claimed characteristics will be disclosed in the following description of the preferred embodiments and the accompanying drawings.

### BRIEF DESCRIPTION OF THE DRAWINGS

FIG. 1 is an overall schematic structural view showing a mobile network of one embodiment of the present invention; and

FIG. 2 is a schematic structural view showing a SIM management app of the one embodiment of the present invention.

### DETAILED DESCRIPTION OF THE INVENTION

One embodiment of the present invention will be described below in accordance with accompanying drawings.

In this embodiment, an example is described, wherein a SIM card is provided by an MVNO operator, that is, a Mobile Virtual Network Operator. Also, this embodiment applies similarly to cases with a Mobile Network Operator (hereinafter referred to as “MNO operator”).

An MVNO operator refers to an operator which does not own a physical mobile network, but rents it from an MNO operator, which actually owns the mobile network, to thereby provide a communication service with said operator's own house brand.

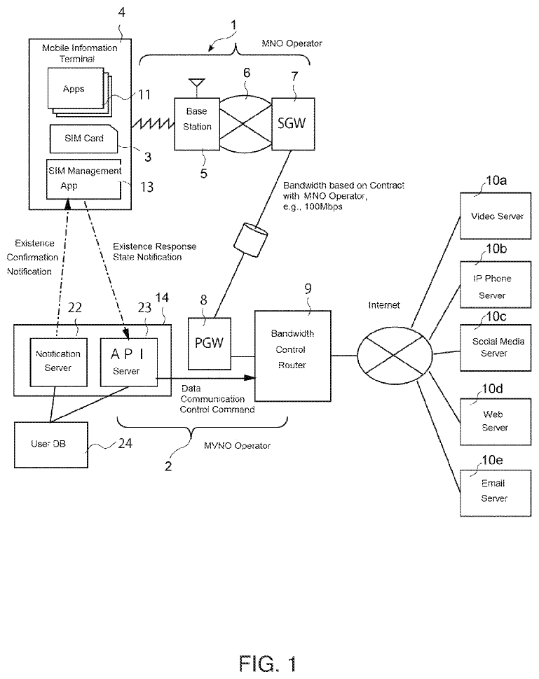

Before describing a characteristic configuration of the present invention, for the purposes of understanding the present invention, an example of data communication environment utilizing a SIM card of an MVNO operator will be first described with reference to FIG. 1.

### (Data Communication Configuration)

Indicated as 1 in FIG. 1 is a mobile network system of an MNO operator, and indicated as 2 is a network connection system of an MVNO operator (a telecommunications carrier of the present invention).

In this embodiment example, a user, who purchased a SIM card 3 under a contract with the MVNO operator, installs the SIM card 3 in the user's own mobile information terminal 4 and activates the SIM card 3. Thus, this mobile information terminal 4 is connected to the mobile network system 1 of the MNO operator through a base station 5 and subsequently becomes capable of connect with various service-providing servers 10a-10e on the Internet from a service gateway 7 (SGW) on the MVO operator and a bandwidth control router 9 on the MVNO operator side.

Between the service gateway 7 (SGW) on the MVO operator and the packet gateway 8 (PGW) on the MVNO operator side, there is a communication bandwidth, for example 100 Mbps, configured to be reserved based on a contract between the MVO operator and the MVNO operator. Also, the bandwidth control router 9 of the MVNO operator is adapted to reserve a required connection bandwidth to enable data communication based on the contract with the user of the SIM card 3.

The mobile information terminal 4 of the user is a terminal with the SIM card (including an electronic SIM) 3 installed therein to enable mobile communication, and this mobile information terminal 4 is typically a smartphone or a tablet and has a CPU, a RAM and a ROM (not shown). Within the ROM, there are installed an operating software program (hereinafter referred to as an “OS”) such as iOS®, Android®, Windows® or the like, and various application software programs (hereinafter simply referred to as “apps”) 11 as well as data utilized by these OS and apps 11.

Apps 11 installed on the user's mobile information terminal 4 include apps for video software, IP phone, social media, browser, email software, and the like, and the user may install additional apps freely according to the user's preferences. These apps 11 on the mobile information terminal 4 are adapted such that they are called onto the RAM, deployed and executed by the CPU to enable connection to the Internet through the mobile network system 1 of the MNO operator and the network connection system 2 of the MVNO operator.

### (Characteristic Configuration of the Present Invention)

In the present embodiment, a SIM management app 13 is installed in the user's mobile information terminal 4, and a SIM communication controller 14 for communicating the SIM management app 13 is provided in the system 2 of the NVNO operator.

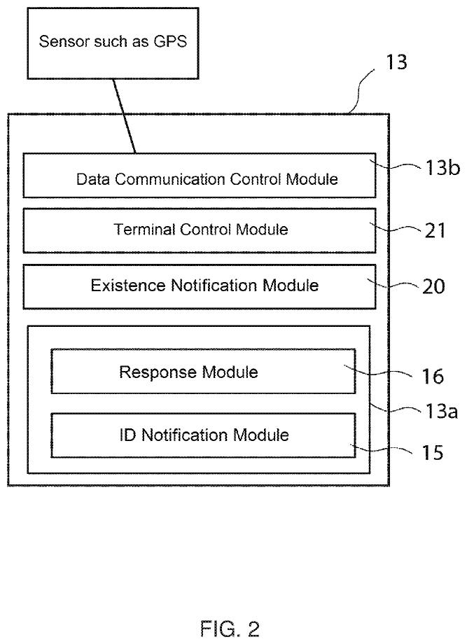

The SIM management app 13 is provided by the MVNO operator itself in order to control data communication and terminal functions using the SIM card 3 of a particular NVNO operator and, as shown in FIG. 2, generally categorized, this SIM management app 13 has an app existence confirmation module 13a, a SIM communication control module 13b and an existence notification module 20 as well as a terminal control module 21 for controlling the terminal functions of this mobile information terminal 4.

The app existence confirmation module 13a has an ID notification module 15 for sending an ID of the SIM card to the SIM communication controller 14; and a response module 16 for sending an existence response signal, which indicates that the SIM management app 13 is being executed, in other words, it exists and have not been uninstalled, in response to a command for existence notification from the SIM communication controller 14.

Also, the SIM communication control module 13b is for setting and controlling various communication modes by the SIM card, and in the present embodiment this SIM communication control module 13b provides services for restricting or allowing communication according to a location detection signal from the GPS. Note that one may additionally contemplate a SIM communication control module 13b for providing a function to adjust a communication speed for each user app.

Also, the existence notification module 20 sends an existence signal to the SIM communication controller 14 at regular intervals. This existence notification module 20 operates independently of the app existence confirmation module 13a, and sends the existence confirmation signal of this app to the SIM communication controller 14 at regular intervals.

Furthermore, the terminal control module 21 performs configuration of various settings other than the setting for SIM communication of the mobile information terminal 4 discussed above as well as configuration of settings for other apps automatically or based on user setting.

On the other hand, the SIM communication controller 14 has a notification server 22 and an API server 23. Firstly, the notification server 22 sends an existence confirmation notification based on a user database (DB) 24 for a mobile information terminal for which the ID notification module 15 notifies an ID. Also, the API server 23 sends a command to turn data communication ON/OFF to the bandwidth control router 9 for each user based on the response signal sent by the response module 16, a data control signal sent by the data control module 13b or the existence notification signal sent by the existence notification module 20.

### (Operation)

In the following, basic operations of the SIM management app 13 will be described.

Firstly, when a user makes a contract on data communication/audio communication with the MVNO operator and purchases a SIM card 3, the user is required to install this SIM card 2 in the user's mobile information terminal 4 as well as to install the SIM management app 13.

When the user installs and launches the SIM management app 13, the ID notification module 15 of this SIM management app 13 obtains an ID of the SIM card 3 and notifies it to the notification server 22.

Upon receipt of the ID notification, the notification server 22 starts sending the existence confirmation notification to the mobile information terminal 4 at regular time intervals thereafter. Upon receipt of the existence confirmation notification, the response module 16 of the SIM management app 13 sends the response signal and calls the API server 23. Here, this API server 23 coordinates with the command for notification of the notification server 22 to keep a record if the response is received within a certain time period, whereas if the response is not received within a certain time period, API server 23 sends a command to the bandwidth control router 9 to turn OFF the data communication of the user's state terminal.

Thus, for example, when the user uninstalls the SIM management app 13 from the user's mobile information terminal 4, the API server 23 cannot receive the response signal, and therefore, the bandwidth control router 9 will turn OFF the user's data communication.

According to such a configuration, when the MVNO communication operator tries uses its own SIM management app 3 to provide various services, for example, bandwidth control for each user, control of the terminal 4 itself and the like, there is an effect to practically prohibit the deletion of the app 3.

Also, the control signals from the SIM communication control module 13b and the existence confirmation module 20 are sent in a manner to call the API server 23.

The existence confirmation module 13b voluntarily sends the existence confirmation command regardless of the notification from the notification server 22, and the API server 23 sends a command to the bandwidth control router 9 to turn OFF the data communication of the user based on the lack of notification within a certain time period after the previous existence confirmation notification.

Note that, when the API server 23 receives the existence confirmation notification after the data communication is turned OFF in either of the above methods, the API server 23 is adapted to send out a command to turn ON the data communication again to the bandwidth control router 9.

It should be mentioned that the present invention is not limited by the above one embodiment example, and that various changes and modifications can be made, without departing from the scope and spirit of the present invention.

For example, the command to turn the data communication ON/OFF is received at the API for processing in the above description, but this may be achieved in other methods.

Also, in the above one embodiment, the telecommunications carrier of the present invention was an MVNO operator, but it may be an MNO operator.

### DESCRIPTION OF THE REFERENCE NUMBERS

1. Mobile network system
2: Network connection system
3. SIM card
4. Mobile information terminal
5. Base station
6. Packet gateway
7. Service gateway
9. Bandwidth control router
10a-10e. Various service-providing servers
11. Various apps
13. SIM management app
13a. App existence confirmation module
13b. SIM communication control module
14. SIM communication controller
15. ID notification module
16. Response module
20. Existence notification module
22. Notification server
23. API server
24. User database

1. A method executed by a computer software program installed in a mobile information terminal having implemented therein a SIM (Subscriber Identity Module) provided by a telecommunications carrier, for controlling data communication, terminal functions and the like of the mobile information terminal, the method comprising a step of:
causing the mobile information terminal to send an existence signal, indicating that the program is being executed, to a data communication control server of the telecommunications carrier in response to a predetermined existence confirmation command, and
wherein if the data communication control server does not receive the existence signal from the program sent in response to the existence confirmation command, the data communication control server sends a command to a mobile network connection controller connected to the mobile information terminal to stop data communication by the SIM.

2. The method as in claim 1,
wherein the existence confirmation command is received from the data communication control server, and
wherein if the data communication control server does not receive the existence signal from the program sent in response to the existence confirmation command within a certain time period, the data communication control server sends a command to the mobile network connection controller to stop data communication by the SIM.

3. The method as in claim 1,
wherein the existence confirmation command is generated at regular time intervals within the mobile information terminal,
wherein if the data communication control server does not receive the existence signal from the program sent in response to the existence confirmation command at regular time intervals, the data communication control server sends a command to the mobile network connection controller to stop data communication by the SIM.

4. The method as in claim 1,
further comprising a step of:
generating, by a data communication control module, a command regarding data communication control based on an event detected within the mobile information terminal; and sending, by the data communication control module, the command to the data communication control server.

5. A data communication control server for communicating with a computer software program installed in a mobile information terminal having implemented therein a SIM (Subscriber Identity Module) provided by a telecommunications carrier, the computer software program for controlling data communication, terminal functions and the like of the mobile information terminal,
wherein the computer software program causes the mobile information terminal to send an existence signal, indicating that the program is being executed, to a data communication control server of the telecommunications carrier in response to a predetermined existence confirmation command, and
wherein if the data communication control server does not receive the existence signal from the program sent in response to the existence confirmation command, the data communication control server sends a command to a mobile network connection controller connected to the mobile information terminal to stop data communication by the SIM.

6. The data communication control server of claim 5,
wherein the existence confirmation command is sent by the data communication control server, and
wherein if the data communication control server does not receive the existence signal from the program sent in response to the existence confirmation command within a certain time period, the data communication control server sends a command to the mobile network connection controller to stop data communication by the SIM.

7. The data communication control server of claim 5,
wherein the existence confirmation command is generated at regular time intervals within the mobile information terminal,
wherein if the data communication control server does not receive the existence signal from the program sent in response to the existence confirmation command at regular time intervals, the data communication control server sends a command to the mobile network connection controller to stop data communication by the SIM.
